(19) United States
(12) Patent Application Publication
(10) Pub. No.: US 2008/0192885 A1
(43) Pub. Date: Aug. 14, 2008

(54) CT SCANNER INCLUDING A SENSOR WHICH IS ACTIVATED TO ALLOW MANUAL ROTATION OF GANTRY

(76) Inventors: Dejan Teofilovic, Ann Arbor, MI (US); Miodrag Rakic, Redondo Beach, CA (US); Joseph Webster Stayman, Ann Arbor, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/030,341

(22) Filed: Feb. 13, 2008

Related U.S. Application Data
(60) Provisional application No. 60/889,613, filed on Feb. 13, 2007.

(51) Int. Cl. G01N 21/00

(52) U.S. Cl. 378/4

(57) ABSTRACT

A CT scanner includes a gantry, a handle, and a sensor located on or connected to the handle. During operation of the CT scanner, a control provides a signal to a motor to rotate the gantry about an axis of rotation. When the CT scanner is not taking a CT scan, a locking mechanism locks the gantry to prevent rotation of the gantry. When the sensor detects an operator, the control provides a signal to disengage the locking mechanism, allowing the gantry to freely rotate about the axis of rotation. When the sensor no longer detects the operator, the control sends a signal to lock the locking mechanism and lock the gantry in the current position.

### REFERENCE TO RELATED APPLICATIONS

This application claims priority to U.S. Provisional Patent Application No. 60/889,613 filed Feb. 13, 2007.

### BACKGROUND OF THE INVENTION

The present invention relates generally to a CT scanner including a gantry that can be manually rotated about an axis of rotation when a sensor is activated.

A CT scanner takes a plurality of x-ray images of a part of a patient to create a three dimensional CT image. The CT scanner includes a gantry that supports and houses components of the CT scanner. The gantry includes a cross-bar section, a first arm that houses an x-ray source that generates x-rays and a second arm that houses a complementary flat-panel detector. During a CT scan, a motor rotates the gantry around the patient about an axis of rotation, and the detector takes a plurality of x-ray images at a plurality of rotational positions. In prior CT scanners, the gantry is locked and cannot rotate about the axis of rotation when the CT scanner is not taking a CT scan.

### SUMMARY OF THE INVENTION

A CT scanner includes a gantry, a handle, and a sensor located on or connected to the handle. The sensor can be activated by touch or by detecting the presence of an operator.

A motor rotates the gantry about an axis of rotation. During operation of the CT scanner, a control provides a signal to the motor to rotate the gantry. When the CT scanner is not taking a CT scan, a locking mechanism locks the gantry to prevent rotation of the gantry.

When the sensor is activated by detecting an operator, the control provides a signal to release or disengage the locking mechanism, allowing the gantry to freely rotate about the axis of rotation. The operator can then manually rotate the gantry. When the sensor no longer detects the presence of the operator, the control sends a signal to lock the locking mechanism and the gantry in the current position, preventing rotation of the gantry.

These and other features of the present invention will be best understood from the following specification and drawings.

### BRIEF DESCRIPTION OF THE DRAWINGS

FIG. 1 schematically illustrates a first embodiment CT scanner including a touch sensor;

FIG. 2 illustrates the CT scanner of FIG. 1 with a part of a person received in the CT scanner;

FIG. 3 illustrates a second embodiment of the CT scanner including a touch sensor; and

FIG. 4 illustrates a computer employed with the CT scanner.

### DESCRIPTION OF THE PREFERRED EMBODIMENT

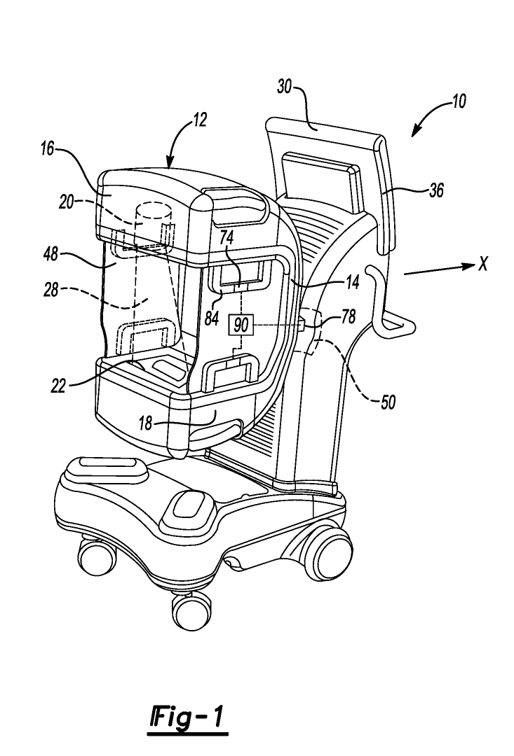

FIG. 1 illustrates a CT scanner 10 including a gantry 12 that supports and houses components of the CT scanner 10. In one example, the gantry 12 includes a cross-bar section 14, and a first arm 16 and a second arm 18 each extend substantially perpendicularly from opposing ends of the cross-bar section 14 to form the c-shaped gantry 12. The first arm 16 houses an x-ray source 20 that generate x-rays 28. In one example, the x-ray source 20 is a cone-beam x-ray source. The second arm 18 houses a complementary flat-panel detector 22. The x rays 28 are directed toward the detector 22 which includes a converter (not shown) that converts the x-rays 28 from the x-ray source 20 to visible light and an array of photodetectors behind the converter to create an image. As the gantry 12 rotates about the patient P, the detector 22 takes a plurality of x-ray images at a plurality of rotational positions. Various configurations and types of x-ray sources 20 and detectors 22 can be utilized, and the invention is largely independent of the specific technology used for the CT scanner 10.

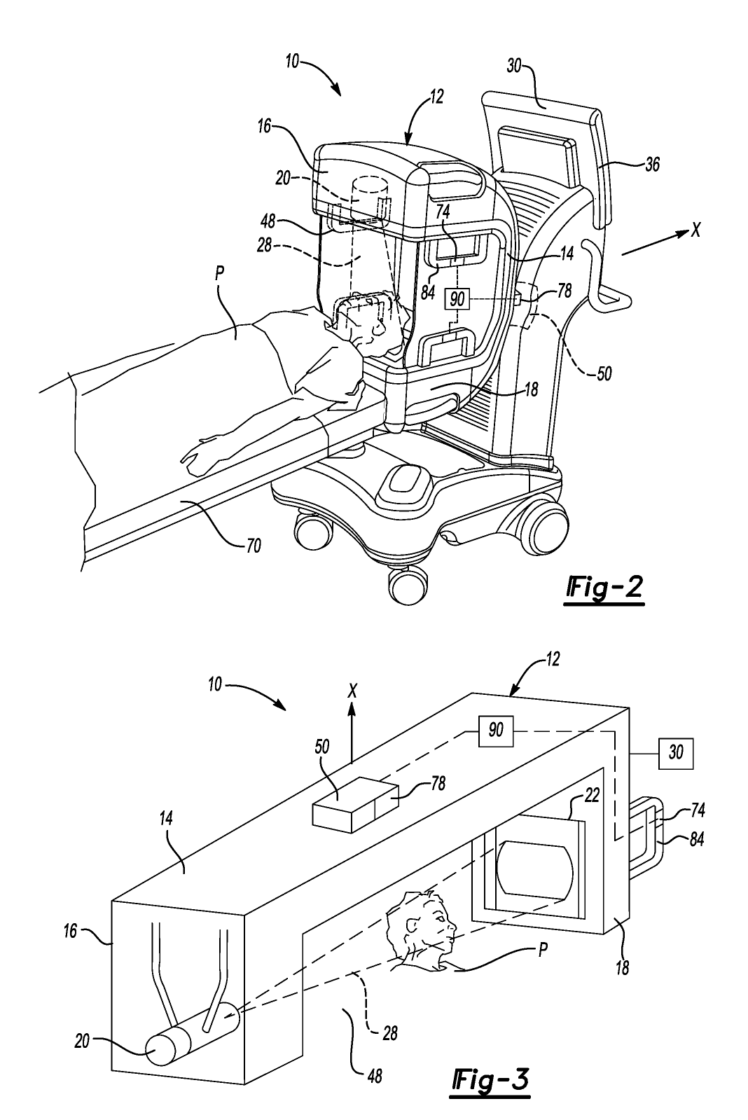

FIG. 2 illustrates the CT scanner 10 with a part of the patient P received in a space 48 between the first arm 16 and the second arm 18. A motor 50 rotates the gantry 12 about an axis of rotation X to obtain a plurality of x-ray images of the patient P at the plurality of rotational positions. The axis of rotation X is positioned between the x-ray source 20 and the detector 22. The gantry 12 can be rotated approximately slightly more than 360 degrees about the axis of rotation X. In one example, as shown in FIGS. 1 and 2, the axis of rotation X is substantially horizontal. In this example, the patient P is typically lying down on a table 70. Alternatively, as shown in FIG. 3, the axis of rotation X is substantially vertical. Typically, in this example, the patient P is sitting upright.

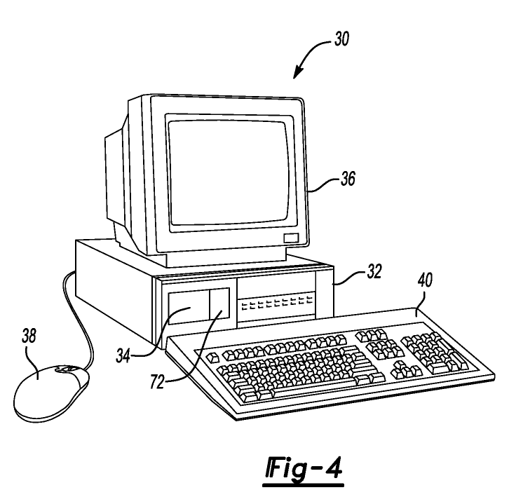

As shown schematically in FIG. 4, the CT scanner 10 further includes a computer 30 having a microprocessor or CPU 32, a storage 34 (memory, hard drive, optical, and/or magnetic, etc), a display 36, a mouse 38, a keyboard 40 and other hardware and software for performing the functions described herein. The computer 30 powers and controls the x-ray source 20 and the motor 50. The plurality of x-ray images taken by the detector 22 are sent to the computer 30. The computer 30 generates a three-dimensional CT image from the plurality of x-ray images utilizing any known techniques and algorithms. The three-dimensional CT image is stored on the storage 34 of the computer 30 and can be displayed on the display 36 for viewing.

Returning to FIG. 1, the CT scanner 10 includes a handle 84 that can be grabbed by an operator. In one example, a sensor 74 is located on or connected to the handle 84. The CT scanner 10 can include four handles 84, and a sensor 74 can be located on or connected to each of the four handles 84 of the CT scanner 10. However, the sensor 74 can be located anywhere on the gantry 12 or on the CT scanner 10. The sensor 74 can be a capacitance sensor, a pressure sensor, a mechanical sensor, or a switch. However, any type of sensor 74 can be employed. The sensor 74 can be activated by touch or by the detection of the presence of the operator, such as the presence of the operator's hand. For example, if the sensor 74 is a capacitance sensor, the operator can wave his hand near the sensor 74, and the change in capacitance detects the operator's hand. If the sensor 74 detects the presence of the operator, the sensor 74 is insensitive to touch.

The CT scanner 10 includes a control 90 that controls the motor 50 and the rotation of the gantry 12. During operation of the CT scanner 10, the control 90 provides an operation signal to the motor 50 to rotate the gantry 12 about the axis of rotation X. When the CT scanner 10 is not being operated or taking a CT scan, a locking mechanism 78 locks the gantry 12 and prevents rotation of the gantry 12 about the axis of rotation X. For example, the locking mechanism 78 can be a series of gears, a motor, a clutch, a solenoid brake or any type of locking mechanism. Alternatively, the motor 50 could lock the gantry 12 in place or a brake or a clutch could be applied.

The sensor 74 also communicates with the control 90. When the sensor 74 is activated, such as by detection of the hand of the operator or by touch, the control 90 provides a signal to release or disengage the locking mechanism 78, allowing the gantry 12 to freely rotate about the axis of rotation X. The operator can then use the handle 84 and manually rotate the gantry 12 about the axis of rotation X.

For example, if the CT scanner 10 is moved to a new location, the operator can activate the sensor 74 by touching the sensor 74 or by waving a hand near the sensor 74. When the sensor 74 detects the operator, the control 90 sends the signal to release the locking mechanism 78. The operator can then grab the handle to manually rotate the gantry 12 about the axis of rotation X. The operator can rotate the gantry 12 to ensure that the gantry 12 does not hit the patient P or anything in the room and that no objects prevent the gantry 12 from rotating during the CT scan. Therefore, the operator can ensure that the gantry 12 can safely rotate when the CT scanner 10 operates during a CT scan.

After the CT scanner 10 is manually rotated about the axis of rotation X by the operator, the operator releases the gantry 12. The sensor 74 no longer detects the operator's hand or touch, and the control 90 sends a signal to lock the locking mechanism 78 and lock the gantry 12 in the current position. The gantry 12 is then prevented from freely rotating about the axis of rotation X. Once the locking mechanism 78 is locked, the gantry 12 is again locked and can only be rotated about the axis of rotation X by the motor 50 during a CT scan.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A CT scanner comprising:
a gantry rotatable about an axis of rotation;
an x-ray source housed in the gantry to generate x-rays;
an x-ray detector housed in the gantry and mounted opposite the x-ray source to obtain a plurality of x-ray images;
a sensor, wherein the gantry is manually rotatable about the axis of rotation when the sensor is activated.

2. The CT scanner as recited in claim 1 wherein the gantry includes a cross-bar section, a first arm and a second arm that each extend substantially perpendicularly to the cross-bar section, wherein the x-ray source is housed in the first arm and the x-ray detector housed in the second arm.

3. The CT scanner as recited in claim 1 wherein the gantry includes a handle that can be grabbed by an operator, and the sensor is on or connected to the handle.

4. The CT scanner as recited in claim 1 wherein the CT scanner includes four handles, and a sensor is located on or connected to each of the four handles.

5. The CT scanner as recited in claim 1 wherein the sensor is one of a capacitance sensor, a pressure sensor, a mechanical sensor and a switch.

6. The CT scanner as recited in claim 1 wherein the sensor detects an operator of the CT scanner, and the sensor is activated when the sensor detects the operator.

7. The CT scanner as recited in claim 1 further including a motor that rotates the gantry about the axis of rotation during a CT scan and a control that provides an operation signal to the motor to rotate the gantry about the axis of rotation during the CT scan.

8. The CT scanner as recited in claim 6 further including a locking mechanism that locks the gantry to prevent rotation of the gantry about the axis of rotation when the CT scanner is not taking a CT scan.

9. The CT scanner as recited in claim 8 wherein the locking mechanism is a series of gears, a motor, a clutch or a solenoid brake.

10. The CT scanner as recited in claim 8 wherein the control provides an unlocking signal when the sensor is activated to release the locking mechanism to allow the gantry to be manually rotated about the axis of rotation.

11. The CT scanner as recited in claim 8 wherein the control provides a locking signal when the sensor is inactivated to lock the locking mechanism to prevent the gantry from being manually rotated about the axis of rotation.

12. A CT scanner comprising:
a gantry rotatable about an axis of rotation, the gantry including a cross-bar section, a first arm and a second arm that each extend substantially perpendicularly to the cross-bar section;
an x-ray source housed in the first arm to generate x-rays;
an x-ray detector housed in the second arm and mounted opposite the x-ray source to obtain a plurality of x-ray images;
a motor to rotate the gantry about the axis of rotation during a CT scan;
a locking mechanism that locks the gantry to prevent rotation of the gantry about the axis of rotation when the CT scanner is not taking the CT scan;
a handle on the gantry that can be grabbed by an operator;
a sensor, wherein the sensor detects the operator of the scanner, the sensor is activated when the sensor detects the operator, and the gantry is manually rotatable about the axis of rotation when the sensor is activated; and
a control, wherein the control provides an operation signal to the motor to rotate the gantry about the axis of rotation during the CT scan, provides an unlocking signal when the sensor is activated to release the locking mechanism to allow the gantry to be manually rotated about the axis of rotation, and provides a locking signal when the sensor is inactivated to lock the locking mechanism to prevent the gantry from being manually rotated about the axis of rotation.

13. The CT scanner as recited in claim 12 wherein the sensor is on or connected to the handle.

14. The CT scanner as recited in claim 12 wherein the CT scanner includes four handles, and a sensor is located on or connected to each of the four handles.

15. The CT scanner as recited in claim 12 wherein the sensor is one of a capacitance sensor, a pressure sensor, a mechanical sensor and a switch.

16. The CT scanner as recited in claim 12 wherein the locking mechanism is a series of gears, a motor, a clutch or a solenoid brake.

17. A method of adjusting a position of a gantry of a CT scanner, the method comprising the steps of:
activating a sensor of a CT scanner; and
manually rotating a gantry of the CT scanner about an axis of rotation when the sensor is activated.

18. The method as recited in claim 17 further including the step of taking a CT scan including the steps of rotating the gantry about the axis of rotation, generating x-rays and obtaining a plurality of x-ray images.

19. The method as recited in claim 17 wherein the step of manually rotating the gantry includes grabbing a handle of the gantry and moving the handle to move the gantry.

20. The method as recited in claim 17 wherein the step of activating the sensor includes detecting an operator of the CT scanner.

21. The method as recited in claim 17 further including the step of locking the gantry to prevent rotation of the gantry about the axis of rotation when the CT scanner is not taking a CT scan.

22. The method as recited in claim 17 further including the step of providing an unlocking signal after the step of activating the sensor to allow the gantry be manually rotated about the axis of rotation.

23. The method as recited in claim 17 further including the step of providing a locking signal when the sensor is inactivated to prevent the gantry from being manually rotated about the axis of rotation.
